(19) United States
(12) Patent Application Publication
(10) Pub. No.: US 2013/0112678 A1
(43) Pub. Date: May 9, 2013

(54) WELDING MONITORING SYSTEM AND METHOD

(71) Applicants: Jae Geun Park, Geoje-si (KR); Yong Woo Kang, Geoje-si (KR); Tae Hyuck Yoon, Geoje-si (KR); Eui Koog Ahn, Incheon (KR); Lock-Jo Koo, Yongin-si (KR); Hee Won Jo, Chungju-si (KR); Seung Taek Hong, Yongin-si (KR); Chang Ho Lee, Gunpo-si (KR); Gi Nam Wang, Suwon-si (KR); Sang Chul Park, Yongin-si (KR)

(72) Inventors: Jae Geun Park, Geoje-si (KR); Yong Woo Kang, Geoje-si (KR); Tae Hyuck Yoon, Geoje-si (KR); Eui Koog Ahn, Incheon (KR); Lock-Jo Koo, Yongin-si (KR); Hee Won Jo, Chungju-si (KR); Seung Taek Hong, Yongin-si (KR); Chang Ho Lee, Gunpo-si (KR); Gi Nam Wang, Suwon-si (KR); Sang Chul Park, Yongin-si (KR)

(73) Assignee: UDMTEK CO., LTD., Suwon-si, Gyeonggi-do (KR)

(21) Appl. No.: 13/808,849

(22) PCT Filed: Jun. 5, 2011
(86) PCT No.: PCT/KR11/04898

§ 371 Date: Jan. 7, 2013

(30) Foreign Application Priority Data
Jul. 5, 2010 (KR) 10-2010-0064194

(51) Int. Cl. B23K 37/00

(52) U.S. Cl. CPC B23K 37/00
USPC 219/148

(57) ABSTRACT

Provided are a system and a method for monitoring welding operations. The system includes a welding machine, a current sensor sensing an operation time of the welding machine and a welding current, a welding information database storing information of the operation time of the welding machine and the welding current for each welding operator and storing information of a consumed charge amount of the welding machine, which is preset for each welding operation process, a data analyzer checking a charge amount consumed for the operation time by using the sensed operation time of the welding machine and the welding current and determining whether the welding operator achieves a task goal of a corresponding process by comparing the checked consumed charge amount with the preset consumed charge amount for a process performed by the welding machine, and a display unit outputting a result of the determining, performed by the data analyzer, whether the welding operator achieves a task goal of a corresponding process.

### CROSS-REFERENCE TO RELATED APPLICATIONS

This application is a national stage application of PCT Application No. PCT/KR/2011/004898, filed Jul. 5, 2011, which claims the benefit of Korean Application No. 10-2010-0064194, filed Jul. 5, 2010, in the Korean Intellectual Property office, the disclosures of which are incorporated herein by reference.

### BACKGROUND OF THE INVENTION

1. Field of the Invention

The present invention relates to a system and a method for monitoring welding operations, and more particularly, to a system and a method for monitoring performance of a welding operator by checking an operation time of a welding machine and a current consumption amount according to the welding operation time.

2. Description of the Related Art

In a workplace where there is needed welding such as a shipbuilding field, performance of a welding operator is evaluated based on work amounts directly inputted by the welding operator or evaluated by a field manager figuring out the work amount of the welding operator.

However, in case of the evaluation based on the work amount directly inputted by the welding operator, since it is complicated to aggregate performance after welding operation, the welding operator may not properly input the performance. Due thereto, inputted performance information may not be reliable.

On the other hand, in case of the evaluation in which the field manager figures out the work amount of the welding operator, reliability of performance information increases but there are consumed a lot of time to check progress specification of work. Due thereto, there may be not enough time to improve work environments or to improve productivity.

### SUMMARY OF THE INVENTION

The present invention provides a system and a method for monitoring welding operations in which performance of a welding operator is evaluated by checking an operation time of a welding machine for each operation process and a current consumption amount for the operation time of the welding machine.

According to an aspect of the present invention, there is provided a welding monitoring system. The system includes a welding machine, a current sensor sensing an operation time of the welding machine and a welding current, a welding information database storing information of the operation time of the welding machine and the welding current for each welding operator and storing information of a consumed charge amount of the welding machine, which is preset for each welding operation process, a data analyzer checking a charge amount consumed for the operation time by using the sensed operation time of the welding machine and the welding current and determining whether the welding operator achieves a task goal of a corresponding process by comparing the checked consumed charge amount with the preset consumed charge amount for a process performed by the welding machine, and a display unit outputting a result of the determining, performed by the data analyzer, whether the welding operator achieves a task goal of a corresponding process.

The data analyzer may store the checked charge amount in the welding information database.

According to another aspect of the present invention, there is provided a method of monitoring welding operations by using a welding monitoring system. The method includes sensing an operation time of a welding machine and a welding current by using a current sensor, checking a charge amount consumed for the operation time by using the sensed operation time of the welding machine and the welding current, and determining whether the welding operator achieves a task goal of a corresponding process by comparing the checked consumed charge amount with the preset consumed charge amount for a process performed by the welding machine and outputting a result of the determining.

The method may further include, before the checking a charge amount consumed for the operation time, storing the sensed operation time of the welding machine and the welding current in a welding information database.

The method may further include storing the checked charge amount in the welding information database.

In case of the system and method for monitoring welding operations according to the embodiments of the present invention, performance of a welding operator is evaluated by checking an operation time of a welding machine for each operation process and a current amount consumed for the operation time of the welding machine, thereby increasing reliability of performance information and spending a lot of time to improve working environments or to increase productivity.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a configuration view illustrating a welding monitoring system according to an embodiment of the present invention; and

FIG. 2 is a flowchart illustrating a method of monitoring welding operations used in the welding monitoring system according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, there will be described exemplary embodiments of the present invention with reference to the attached drawings. When it is determined that a detailed description on functions or configurations well known in the art may cloud the issue of the present invention, the description thereof will be omitted. Also, terms described later are defined considering functions in the present invention, which may vary with intensions or practices of users or operators. Accordingly, the definition thereof should be understood based on the concepts through the present specification.

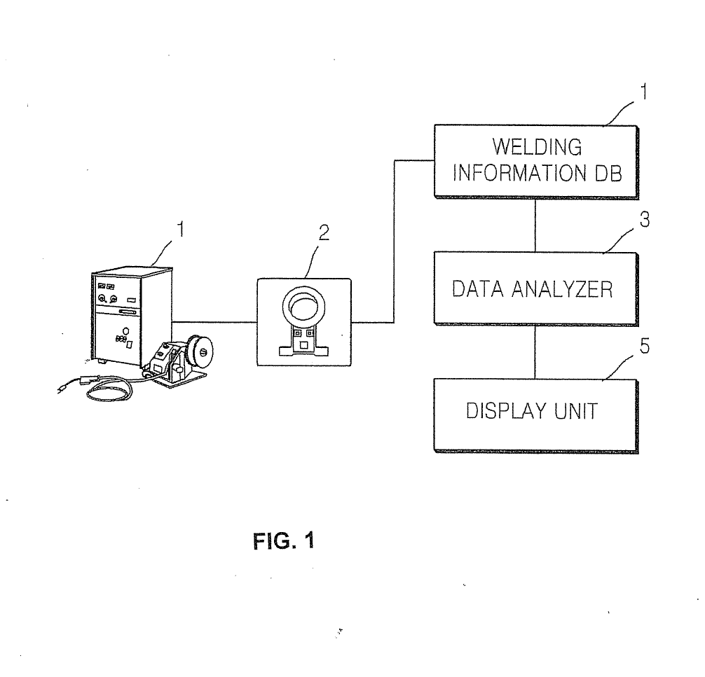

FIG. 1 is a configuration view illustrating a welding monitoring system according to an embodiment of the present invention. The welding monitoring system includes a welding machine 1, a current sensor 2, a data analyzer 3, a welding information database 4, and a display unit 5.

The current sensor 2 senses an operation time of the welding machine 1 and a welding current and provides the same to the data analyzer 3. The welding information database 4 stores information on the operation time of the welding machine 1 and the welding current sensed by the current sensor 2 for each welding operator for each welding process operation and stores preset consumed charge amount information of the welding machine 1 for each welding operation process.

The data analyzer 3 checks a charge amount consumed for the operation time by using the operation time of the welding machine 1 and the welding current sensed by the current sensor 2, compares the checked consumed charge amount with the preset consumed charge amount of a process performed by the welding machine 1, and outputs a result of achieving a task goal of a corresponding process of the welding operator via the display unit 5. In this case, the charge amount consumed for the operation time of the welding machine 1 may be obtained by multiplying the operation time of the welding machine 1 by the welding current. Additionally, the data analyzer 3 may store the checked consumed charge amount in the welding information database 4. Accordingly, a field manager of a welding operation area may check a welding operation progress and performance of the welding operator from the result of achieving the task goal for each process.

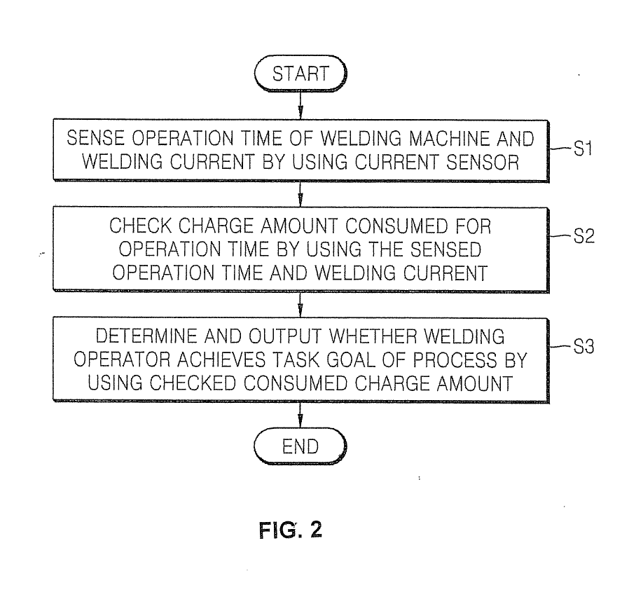

FIG. 2 is a flowchart illustrating a method of monitoring welding in the welding monitoring system according to another embodiment of the present invention.

As shown in FIG. 2, the welding monitoring system senses an operation time of the welding machine 1 and a welding current by using the current sensor 2 (S1).

The welding monitoring system checks a charge amount consumed for the operation time using the operation time of the welding machine 1 and the welding current sensed by the current sensor 2 (S2). In this case, the charge amount consumed for the operation time may be obtained by multiplying the operation time of the welding machine 1 by the welding current. Additionally, the welding monitoring system may store the sensed operation time of the welding machine 1 and welding current in the welding information database 4 before checking the charged amount consumed for the operation time. Also, the welding monitoring system may store the checked consumed charge amount in the welding information database 4.

After that, the welding monitoring system compares the checked charge amount with a preset consumed charge amount for a process performed by the welding machine 1 and outputs a result of achieving a task goal for each corresponding process of a welding operator via the display unit 5 (S3).

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

The present invention will be applied to the field of welding industry.

Although a few embodiments of the present invention have been shown and described, it would be appreciated by those skilled in the art that changes may be made in this embodiment without departing from the principles and spirit of the invention, the scope of which is defined in the claims and their equivalents.

1. A welding monitoring system comprising:
a welding machine;
a current sensor sensing an operation time of the welding machine and a welding current;
a welding information database storing information of the operation time of the welding machine and the welding current for each welding operator and storing information of a consumed charge amount of the welding machine, which is preset for each welding operation process;
a data analyzer checking a charge amount consumed for the operation time by using the sensed operation time of the welding machine and the welding current and determining whether the welding operator achieves a task goal of a corresponding process by comparing the checked consumed charge amount with the preset consumed charge amount for a process performed by the welding machine; and
a display unit outputting a result of the determining, performed by the data analyzer, whether the welding operator achieves a task goal of a corresponding process.

2. The system of claim 1, wherein the data analyzer stores the checked charge amount in the welding information database.

3. A method of monitoring welding operations by using a welding monitoring system, the method comprising:
sensing an operation time of a welding machine and a welding current by using a current sensor;
checking a charge amount consumed for the operation time by using the sensed operation time of the welding machine and the welding current; and
determining whether the welding operator achieves a task goal of a corresponding process by comparing the checked consumed charge amount with the preset consumed charge amount for a process performed by the welding machine and outputting a result of the determining.

4. The method of claim 3, further comprising, before the checking a charge amount consumed for the operation time, storing the sensed operation time of the welding machine and the welding current in a welding information database.

5. The method of claim 4, further comprising storing the checked charge amount in the welding information database.
